(19) United States
(12) Patent Application Publication
(10) Pub. No.: US 2004/0036287 A1
(43) Pub. Date: Feb. 26, 2004

(54) Seal for pipelines threaded joints and its use

(76) Inventor: Enrique Trivelli, Buenos Aires (AR)

Correspondence Address: HODGSON RUSS LLP, ONE M & T PLAZA, SUITE 2000, BUFFALO, NY, 14203-2391, US

(21) Appl. No.: 10/647,629

(22) Filed: Aug. 25, 2003

(30) Foreign Application Priority Data
Aug. 26, 2002 (AR) P 02 01 03204

(51) Int. Cl. F16L 25/00

(52) U.S. Cl. 285/333

(57) ABSTRACT

A seal for threaded joints of pipelines formed by pipes with outer threads joined by couplings with inner threads, the seal constituted by a substantially cylindrical sleeve of elastomeric material, wherein the outer surface of the sleeve has at least on part of its length a thread engaging the inner thread of the coupling. The sleeve can be enlarged at both ends by sealing lips. Preferably, the seal is used for joints of pipelines to convey fluids, especially corroding fluids, hydrocarbons and its derivates, and the like.

### CLAIM FOR PRIORITY

This application claims priority to Argentine patent application serial no. P 02 01 03204, which was filed on Aug. 26, 2002.

The present invention relates to a seal for threaded joints for pipelines formed by pipes with outer threads joined by means of conical or cylindrical couplings.

Pipes used at present to convey fluids, for example in the petroleum or chemical industry, or the like, are formed by joined pipe sections 6 to 13-meter long, which usually have an inner lining resistant to corroding fluids. Joining of the pipe sections to form pipelines of sufficient length have always been a problem. The pipes may have an inner lining, for example a layer of cured epoxi paint, formed by one or more coats of paint depending on each component, resulting in a protective layer about 250-300 microns-thick.

There have also been different proposals for pipes with inner lining of plastic material.

The problem for assembling a pipeline from metallic pipes with inner lining of paint or plastic material is providing a tight seal, with sleeves or retainers, at the joining area. These seals shall present an inner surface substantially smooth, to avoid accumulation of impurities dragged by the fluid conveyed through the pipeline and/or to prevent the diameter of the pipe being reduced, which may cause a flow reduction. The joint is formed by metallic couplings with inner threads, which mate with outer threads on the pipes to be joined. The sleeves or retainers used at present only provide an unsatisfactory seal, because they are compressed at the area of joint when fastening the threaded couplings. Said compression may cause uncontrollable deformations in the retainer, such as for example shrinking, and these deformations are evident only when the joints start to leak. Also, the inventors have verified that conventional sleeves, whether under fastening pressure of the couplings or simply the hydraulic pressure of the fluid conveyed, tend to extrude towards the interior of the coupling threads. This not only causes deformation but also a shearing effect and probable cracks, which in time may cause the complete destruction of the retainer.

Threaded couplings are worked so that they hermetically fit over the outer threads of the pipes, especially in the case of conical threads. The problem of deformation is dealt with a careful dimensioning of the couplings, to control the thread advance with a certain accuracy. However, the problem has not been totally solved, and leaks and even corrosion appear in the threads, caused by leaking of the fluids conveyed.

The present inventors have verified that at least part of these leaks happen in the outer periphery of the retainers, between them and the inner surface of the coupling, favored by the fact that the inner threads of the couplings extend at least partially over the area that fits the outer threads of the pipes. These areas of the threads create a real channel through which the fluid conveyed can pass, all the more so if the fluid is conveyed under great pressure or flow.

Therefore, the present invention proposes a seal for threaded joints, formed by a substantially cylindrical sleeve of elastomeric material, in which the outer surface of the sleeve has at least in a portion of its length a thread which complements the inner thread of the coupling.

Unexpectedly it could be verified that this construction reduces to a minimum, or even totally avoids, leaks of the conveyed fluid and/or corrosion of the couplings, even though the sleeve is not wholly compressed at the joint. The lack of compression avoids deformation of the sleeve, so that it hermetically fits against the coupling thread. The small gap that may appear between the end of the sleeve and the corresponding end of the pipe can only be filled with the fluid conveyed to where the compression of the air retained in said gap allows, because of the airtight fit of the coupling conical thread over the outer thread of the pipe. The airtightness between the inner thread of the coupling and the outer thread of the sleeve avoids re-circulation unavoidably produced in conventional constructions. If the inventive retainer is subject to a small compression, for example during fastening of the couplings with cylindrical threads, the abutment of all its surfaces, except its inner cylindrical surface, with the metallic surfaces of the coupling and the front surfaces of the pipes, only cause a small swelling in its central inner area, but maintaining the airtightness. On the contrary, airtightness is favored for the retainer abutment with the front surfaces of the pipes, completely avoiding leaks of the fluid conveyed. Also, the retainer abutment wholly avoids the shearing effect mentioned.

In an embodiment of the invention, the sleeve is provided at both ends with sealing lips, which, once the pipeline is assembled, will lay against the inner surface of the respective pipes, producing a sealing effect due to the hydraulic pressure generated by the fluid conveyed. Although the arrangement of the sealing lips is well known per se, the inventors have verified that in conventional sleeves provided with sealing lips, compression of said sleeves due to fastening of the couplings, which caused sleeve deformations as indicated above, caused an interior hollowness of the sleeve and consequent deviation of the lips towards the inside of the pipeline, annulling its sealing function. According to the present invention, this deformation cannot be produced, therefore the combination of a sleeve provided with threaded outer surface and sealing lips is a novel feature.

Sealing sleeves can be made from any plastic or elastomeric material compatible with the fluid to be conveyed, the only condition is to have sufficient elasticity to fulfill the intended function.

The invention will be further described with reference to the following examples and annex drawings, in which:

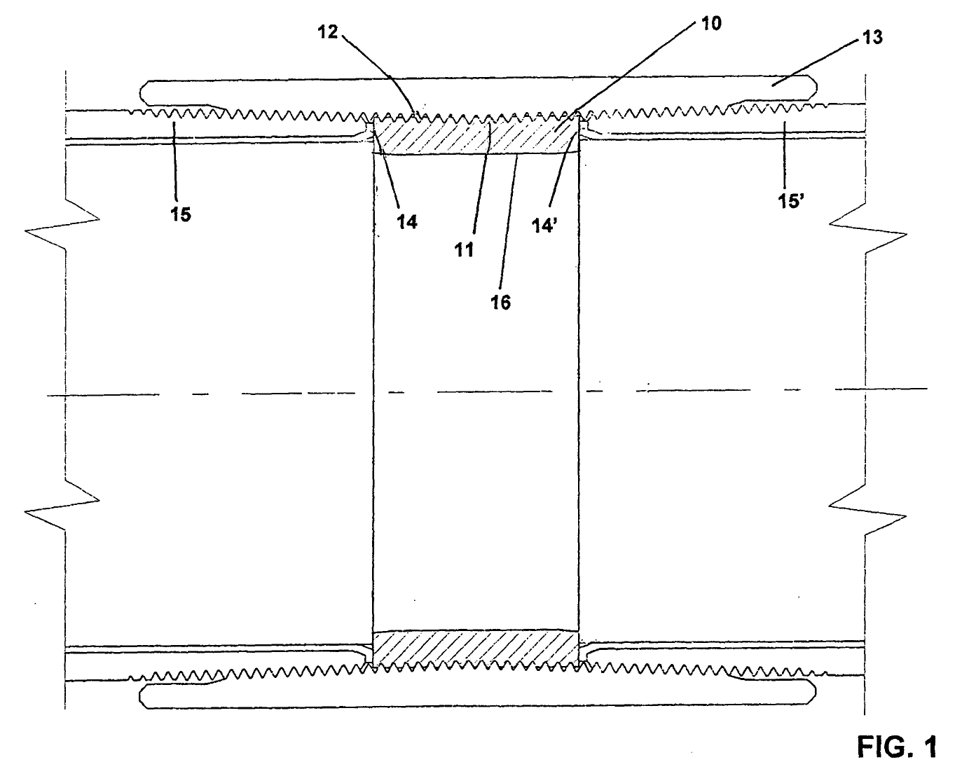

FIG. 1 shows a first embodiment of the present invention.

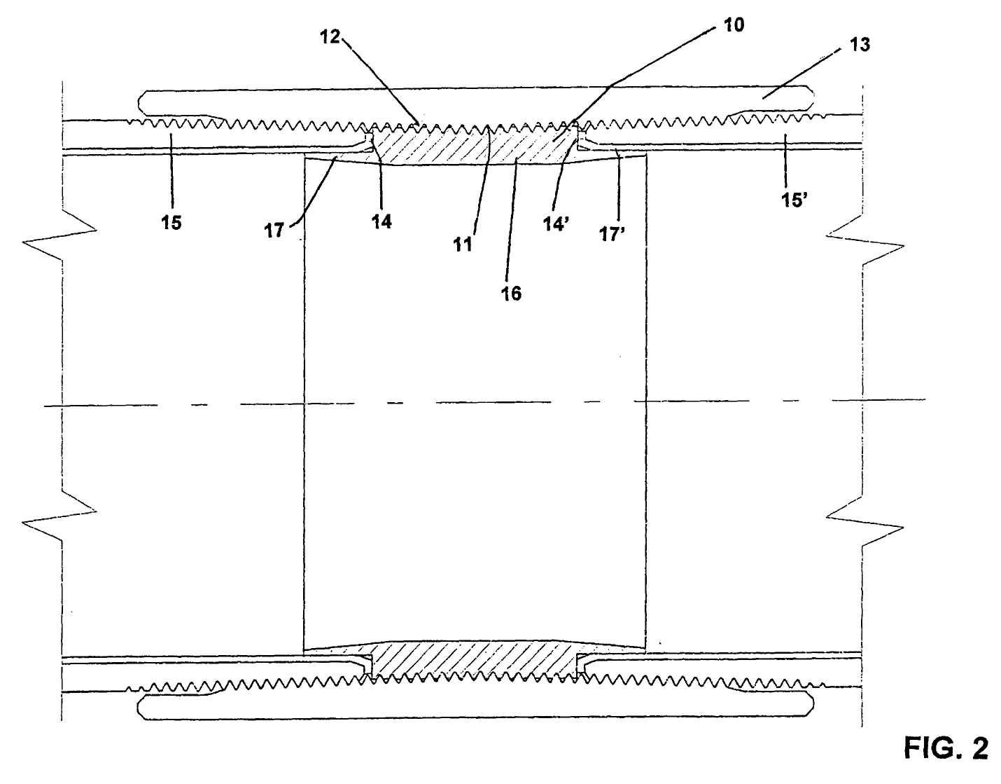

FIG. 2 shows a second embodiment of the present invention.

With reference to FIG. 1, the seal for threaded joints according to the invention is constituted by a sleeve 10 substantially cylindrical, of an elastomeric material. Its outer surface has, at least over part of its length, a thread 11 mating the inner thread 12 of coupling 13. In working position, sleeve 10 is interposed between front surfaces 14, 14′ of the pipes 15, 15′ joined by means of coupling 13 intended to form a pipeline. When joining the pipes, the sleeve can be pressed between front surfaces 14, 14′, producing a slight expansion of its inner surface 16, or it can be separated from said front surfaces by a small gap. In this latter case, a small quantity of fluid conveyed through the pipeline may penetrate said gap, but usually it is stopped by the airtight conical thread of the coupling fastened against the outer thread of the pipes.

In the second embodiment shown in FIG. 2, the sleeve 10 is enlarged at its two front ends by corresponding sealing lips 17, 17′, which when the seal is placed into the pipeline will lay against the inner surface of the pipes under the hydraulic pressure of the fluid conveyed. This embodiment has more tolerance regarding the seal fabrication, since it is not necessary to compress the sleeve and airtightness between the metallic threads is not required. The hydraulic seal formed by the lips prevents leaks of the fluid conveyed, and the hydraulic pressure of the fluid cannot cause any deformation of the sleeve, as it is totally retained by its fastening to the inner thread of the coupling.

### EXAMPLE OF APPLICATION

A 1800 m-long pipeline was made using lined pipes, intended to convey a mixture of petroleum and formation water on an elevation about 100 meters over the level of a pumping station. The pipes were made of steel, having a diameter of 7.3 cm and wall-thickness of 5.50 mm, and were lined with nylon 11 with a thickness of 250 μm. The pipes were joined by conical threaded coupling, interposing cylindrical retainers of synthetic rubber.

After four months of service, about 30% of the threads of the joining couplings were corroded by leaks of the fluid conveyed, to the point of even hampering its replacement.

### COMPARATIVE EXAMPLE

Under similar conditions, the pipes were joined by threaded couplings but interposing seals according to the present invention.

After six months of similar service, there were no leaks. When disassembling some couplings, it was observed that the operation could be easily carried out, and the joints could be re-assembled using even the same couplings, which had no signs of internal corrosion. The only task was replacing the seals of elastomeric material, to prevent the permanent deformation due to aging.

What is claimed is:

1. A seal for threaded joints for pipelines formed by pipes with outer threads joined by couplings with inner threads, the seal constituted by a substantially cylindrical sleeve of elastomeric material, wherein the outer surface of the sleeve has at least in part of its length a thread engaging the inner threads of the coupling.

2. The seal of claim 1, wherein said cylindrical sleeve is enlarged at both ends by sealing lips.

3. Use of a seal according to claims 1 or 2, for the joining by means of threaded coupling of pipes intended to form pipelines to convey fluids, especially corroding fluids, hydrocarbons and its derivates and the like.
